(19) United States
(12) Patent Application Publication
(10) Pub. No.: US 2024/0028315 A1
(43) Pub. Date: Jan. 25, 2024

(54) Automatically Creating Efficient Meshbots

(71) Applicant: Ezlo Innovation LLC, Bloomfield, NJ (US)

(72) Inventor: Melih Abdulhayoglu, Montclair, NJ (US)

(21) Appl. No.: 18/142,226

(22) Filed: May 2, 2023

Related U.S. Application Data
(60) Provisional application No. 63/339,515, filed on May 9, 2022.

(51) Int. Cl. G06F 8/41

(52) U.S. Cl. CPC G06F 8/433; G06F 8/34

(57) ABSTRACT

There is provided a system and method which acquires code to be executed and splits the code into one or more chunks, then identifies for each of the chunks any resources needed. Access for a specific user is determined as to the various network items needed. It is determined that each one of the chunks of code are executable and have access to all of the resources needed and a locality of resources is determined. By reviewing the chunks of code, the method and system determine where the chunks of code should run, and merge all consecutive chunks of code that run on a same computer unit into one unit of code. This unit is then distributed to all the devices that are to run the unit of code by synchronizing the pieces of code with the devices.

### CROSS REFERENCE TO RELATED APPLICATIONS

This application claims benefit of and priority to U.S. Provisional Patent Application Ser. No. 63/339,515 filed on May 9, 2022 incorporated by reference herein in its entirety.

### FIELD OF THE INVENTION

This invention is related to an automation platform for connection of devices.

### BACKGROUND

Old methods with executing code where multiple devices are involved is to place all the code (in one single part) on a single device that can run it, and the code uses resources from other devices via APIs from other devices.

These prior methods have various disadvantages. For example, if the device that is supposed to run the code is not available at that point in time, then the code will not run. Additionally, if the code is complex, or if there is a large number or volume of codes to run then the device that has to execute the code can become slow, unresponsive or unable to run everything due to overload.

### SUMMARY OF THE INVENTION

The present invention overcomes the prior problems by taking a piece or section of generated code and spliting up the piece of generated code into multiple pieces so that each piece of code runs independent of each other piece of code, but also connects the pieces of code through communication protocols, so the functionally (from the user's perspective) is that the code runs as if it were a single piece. These code slices are each capable of distribution to various devices that can run each piece it receives.

In general, any software that has to run or be executed is basically a set of operations with an input and an output. Any operation can require access to a resource and also the input need to be able to be read in.

With the present invention, the following steps are performed. First, the system and method acquires the code which has to be run or executed and splits the code into smallest possible chunks, sections or portions, and then identifying for each chunk, section or portion, what resource(s) the chunk, section or portion of code needs. For example, the method and system determines if the chunk, section or portion of code needs to send a command to another device or to read a file or to store something, item or data in a database.

Next, the system and method of the present invention determines what a specific user has access to—such as cloud instances, edge computing, databases, etc—to check and determine that the code can actually run and has access to all the needed resources.

Then, the system and method of the present invention determines the locality of the resources needed for each chunk, portion or section of code. A local resource is something that is attached to the device running the code—for example, if the system or method of the present invention needs to talk to a device, the system and method checks if it can run that code on that specific device. A remote resource, on the other hand, is something that needs to be used across a local network or internet. So the present invention takes all chunks of code and decides where it should run, then the system and method merges all consecutive chunks that run on the same computer unit into one unit of code.

Then, the system and method have the step of distributing the code to all the devices that are to run it, by synchronizing the pieces of code with the devices that will run it.

The present invention has several advantages over prior methods. The present invention achieves distributed load across multiple devices and also redundancy—once the execution path has been defined, each device can make decisions on how to optimize executing the next part of the code. A second effect of the present invention is that execution has built in redundancy—if one of the devices is not available for any reason, the device's work load is taken up by one or more other device(s). A third benefit is that complex codes, which can consume a lot of resources to run can be split in smaller chunks and distributed to multiple devices to run it—this way each device only has to handle a lower overall load, permitting each device to be involved in running more code.

Included for use with the present invention, there is provided a voice orchestrated infrastructure system for use with and in creating smart homes that are controlled by one or more authorized users from a centralized hub device. For one or more of the rooms in a residence or dwelling, each of the rooms has embedded or fastened in fixtures and devices within the room, microphones and speakers which are in communication with the central hub system and also with each other through the central hub system via wi-fi networking. The system of the present invention is not dependent on any particular brand of voice controlled personal assistant device (such as Siri/Alexa/Nest). Microphones/speakers/ video are all controlled and communicated directly through one hub. Service provider that is utilized does not matter. As the voice orchestrated infrastructure is agnostic as to the system or type of personal assistant device employed by the user(s).

The system has Wi-Fi capability to talk to the hub and authorized devices. Motion detection via sound effects to activate the room devices. All privacy is controlled through the hub, along with security features. Communication system protocol—devices in each room of house or dwelling acting as a telephone.

Voice command is directed to an appropriate destination, such as a room, or particular endpoint device in a room. This includes lights, thermostats, electric outlets, appliances—washer, dryer, stove, refrigerator, oven, range, automated vacuums. Security systems for windows and doors, motion detectors, smoke detectors.

### BRIEF DESCRIPTION OF THE DRAWINGS

FIG. 1 is an illustration of a hub connected to one or more rooms each with endpoint devices;

FIG. 2 is a schematic of the voice orchestrated infrastructure bridge components.

FIG. 3 is a diagram of the bridge components showing drivers, logic layers, and network layers;

FIG. 4 is a diagram of the bridge system components;

FIG. 5 is a schematic of the computer device components of the present invention.

FIG. 6 is schematic of a creating dashboards on a platform for use with the present invention.

FIG. 7 is schematic of a dashboard on a platform for use with the present invention.

### DETAILED DESCRIPTION

With the present invention, there is a system and method of automatically creating efficient Meshbots, which is defined as a complex automation with artificial intelligence, including a trigger and an action, which is registered as true or false logic. This is where the user creates the rules which make up a Meshhot and then the system of the present invention analyzes and determines what could be run as 1.) device associations; 2.) locally at a hub; or 3.) at the cloud and associated servers. in the present invention, the user creates a Meshbot and all the intelligence is handled for the user as to how and where to run this code which the user generated.

Intelligent MeshBots can run in the cloud or the edge, on an operating system, such as MiOS, which runs from cloud to the edge, and edge to cloud. Global meshbots run in the cloud and are not tied to a specific controller. They are device-centric and automatically find the appropriate controller to manage a device. The present invention is a flexible approach which avoids rule duplication and recreation. The administrator or user does not have to remember which controller is in charge of which device. The administrator can move devices from controller to controller, and replace controllers without needing to recreate your entire meshbot rule set. Local meshbots, on the other hand, allow the user or administrator to interact with devices which have been imported to a specific controller. The user or administrator can select the controller associated with the meshbot on a dashboard which serves as the meshbot creation interface.

The present invention also provides virtual device and service capability. Similar to connecting an existing application or device, the user /administrator can also mix-and-match the capabilities of multiple services and devices to create a brand new virtual device/service. This allows for connection, automation and visualization of a new virtual item just as with any other device or service.

The present invention includes two main types of devices which can be added to a local or global meshbot—physical and virtual. Physical devices are what is typically thought of when the term ‘smart device’ is heard. Examples: smart devices often found in homes and buildings include thermostats, light bulbs, door locks, refrigerators, motion detectors, cameras, alarms, doorbells and stereos. Virtual devices work the same way as physical smart devices. The virtual devices save time by consolidating multiple actions to a single command and can act as a ‘universal translator’ for unsupported devices.

An operating system, such as MiOS, allows for creation of a virtual device and set up its states and commands. The commands can be mapped to real device/service commands or cloud device/service commands. A virtual switch, for example, lets you control physical devices that are monitoring the on/off state of the switch.

Virtual devices provide simplicity for the user/admin to activate multiple automations, routines and scenes via a single command to a virtual switch. This saves the time and effort of remembering multiple commands to operate different devices. The virtual devices also act as a switch for devices that don't have switch support.

Virtual devices provide compatibility. Virtual switches provide the user/administrator control of devices that are not supported and/or directly controlled by the voice assistant. First, the user/admin sets the virtual switch to control one of the physical devices and then import the virtual switch to a voice activated system (such as Alexa, for example). The user/admin can then issue voice commands to the virtual switch rather than the device itself. The switch activates a meshbot in EZlogic which, in-turn, sends a command to the physical device.

The virtual devices also have the capability to act as an ‘IF’ for the routines, for example, the user/admin may have a routine that turns on light bulbs in the morning. The user/admin can make this routine conditional to the ‘ON’ state of a virtual switch. If an individual or family wants to sleep late, or intends to sleep late the next day, the user can disable the morning routine with an ‘OFF’ command to the voice assistant (Alexa, etc.).

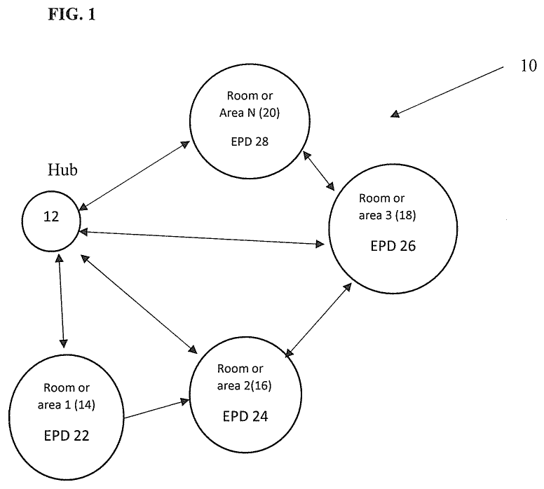

The present invention can be included with a voice orchestrated infrastructure system which is integrated into each room or endpoint device. As illustrated in FIG. 1 for the present invention each of the Room or area 1 (14), Room/area 2 (16), and Room/area 3 (18) and a plurality of other rooms or areas, designated as room or area N (20), are connected and in communication to the hub 12, with each room or area having one or more endpoint devices (EPD) 22, 24, 26, and 28, such a light switches, outlets, appliances etc. All endpoints 22, 24, 26, and 28 are voice orchestrated or controlled and have microphones and speakers at the endpoints 22, 24, 26, and 28 for communication with, from and back to the hub 12. Through the hub 12, communication can be made to and from any room 14, 16, 18 or 20 for activating or deactivating or adjusting /controlling any device or endpoint 22, 24, 26, and 28 in the room. The system 10 can be synched and controlled with laptop or hand held devices as well whether by voice control or applications. Proprietary software and rules are designed for the hub and system to execute the system of the present invention.

### Bridge Description:

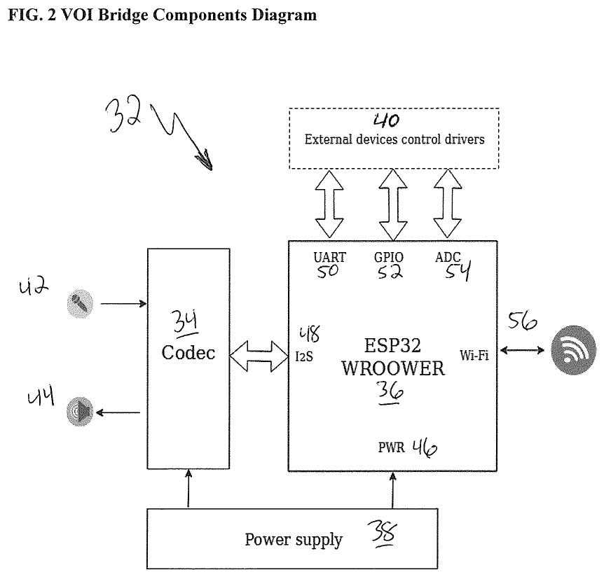

Referring to FIG. 2, there is shown the VOI bridge components 32. The VOI bridge is a small-sized device based on Espressif ESP-32 chip (eXtensa ESP32) 36. The bridge 32 consisting an array of MEMS microphones 42 connected to an audio codec 34 and an ESP32 Wi-Fi/BT enabled 32 bit microcontroller. The MEMs microphone array on the bridge allows you to leverage voice recognition in your app creations by using the latest online cognitive services including Microsoft Cognitive Service, Amazon Alexa Voice Service, Google Speech API, Wit.ai and Houndify. The bridge provides to users the opportunity to integrate custom voice and hardware-accelerated machine learning technology right onto the silicon. It's for makers, industrial and home IoT engineers. It allows for triggering events based on sound detections, such as receiving a text message when your dog is barking back home. One of the examples of working with bridge—you can build your own Amazon's Alexa using the Bridge 32. Bridge contains the following peripherals: ac/dc power converter 38, 46; general purpose input/output 52, universal asynchronous receiver transmitter (UART) 50, analog-digital converter (ADC) 54, voice/sound streaming information 42, 44, 48; network interface; status indicators; control buttons; low power drivers for control external devices 40 (optional); may have wireless 56 interfaces on-board such as Bluetooth/ZigBee/Z-Wave (optional). External audio codec 34 is used for input/output 42, 44 and coding/decoding of voice/sound information 48. Bridge can work/have internal and external microphones and built-in speaker.

In an embodiment, the end points 22, 24, 26, 28 include a voice proximity sensor and can also be combined with an amplification sensor for the sound wave, as well as at least one directional sensor. In this manner, an individual speaking a command (such as “turn lights on” or “turn lights off”) can direct the command to a specific endpoint 22, 24, 26, 28 within a room or a specific room as they enter or leave in order to distinguish from an endpoint in the adjacent room.

### Bridge Functions:

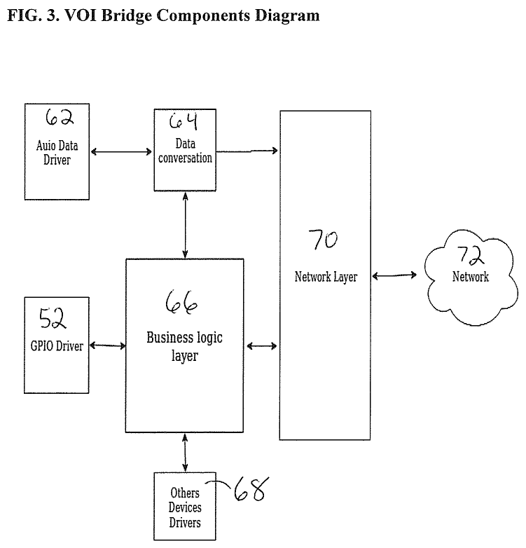

The present invention includes perception of voice commands, coding, transmitting to remote voice web-service 84 (Amazon Alexa, Google Assistant, etc.) using protected HTTP connection. This includes: receiving, uncoding, unpacking and playing of sound/voice response from remote voice web-service. There is also receiving of REST-requests from own web-service (NMA) and control of devices with the help of GPIO's 52 pins or using wireless interfaces. See FIG. 3 to reference the audio data driver 62, communicating and transmitting to data conversion 64 which is in communication with the network layer 70 and business logic layer 66. The business logic layer 66 communicates with the GPIO driver 52 and other device drivers 68. The business logic layer also communicates with the network layer 70 which is in communication with the network 72.

### NMA Functions:

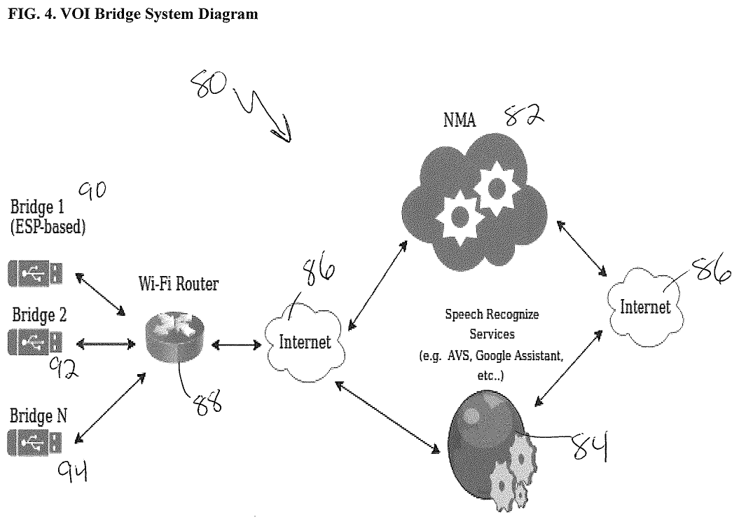

Referring to FIG. 4, there is shown the bridge system diagram 80. This bridge system includes a multitude of ESP based bridges 90, 92, 94 connected and communicating with a Wi-Fi router 88 in connection to the internet 86. Communication with an NMA 82 and a speech recognition services 84 to and from the internet 86 is also provided.

NMA 82 is a web service that contains event handlers for voice web services. It handles requests from a remote voice web service (Amazon Alexa, Google Assistant, etc) 84. It sends REST bridge requests according to its own business logic, which is based on processing events from a remote voice web service.

### Functions of the Remote Voice Web Service.

This service has the functionality to recognize voice information, the formation of a voice response based on intellectual processing of input data (contains intellectual voice chat) and also contains easily configurable voice command handlers (e.g. Alexa Skills) and NMA web service management.

### Working Flow:

After power supply to the bridge, the device enters the standby mode of initialization, which is displayed by the indicator. The device is initialized by pressing the “mic” button or by pre-programmed wake-up word. In the initial initialization mode, the bridge raises the access point with the SSID (brige xxxxx). This is necessary to configure the basic parameters such as WIFI AP and voice web service account 84. Setup is performed using a mobile IOS/Android application. The user installs the mobile application. The mobile device must be connected to the WIFI AP bridge. After successful setting, the bridge disables the access point. To reset the settings, you must hold the “reset” button.

The configured bridge connects to the NMA 82 and also has a connection to the remote voice web service 84. After successfully connecting to the NMA 82, the bridge is waiting for the wake-up voice command word. The user has the ability to customize the wake-up word voice command using a mobile application. User information will be stored in the bridge ROM in encrypted form. The key for encryption is located in a secure section of the flash. These states are accompanied by light/sound indication.

The user initiates voice control of bridge by the wake-up word. After processing of wake-up word, the bridge goes into the mode of transmitting voice information to the voice service. A voice communication session has a specified timeout upon completion of which commands are not transmitted to the voice service. For subsequent sessions, you must repeat the pronunciation of wake-up word. Initialization of communication sessions is accompanied by a light/sound indication. The voice service receives voice information from the bridge, processes the request, sends an audio response to the bridge, and, if necessary, transmits the necessary request to the NMA. NMA in turn controls the bridge. (See FIG. 4).

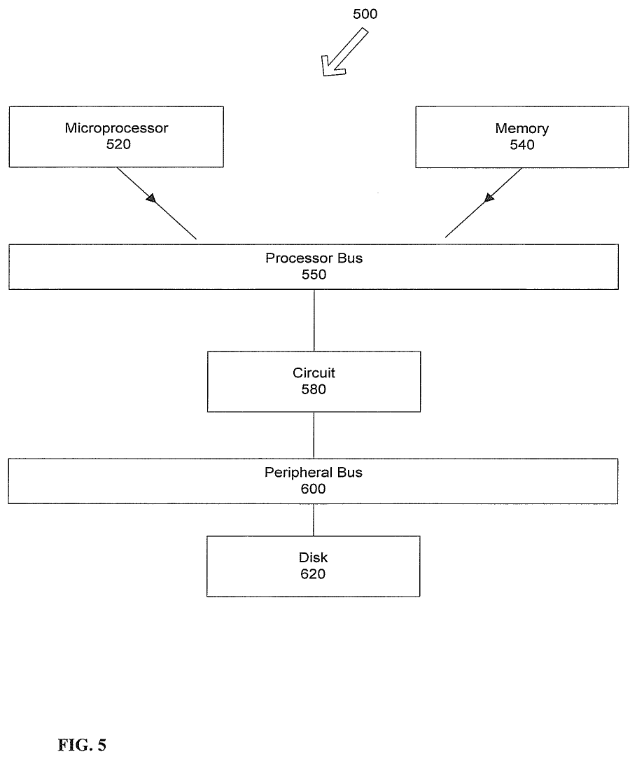

FIG. 5 illustrates a system 500 of a computer or device which includes a microprocessor 520 and a memory 540 which are coupled to a processor bus 560 which is coupled to a peripheral bus 600 by circuitry 580. The bus 600 is communicatively coupled to a disk 620. It should be understood that any number of additional peripheral devices are communicatively coupled to the peripheral bus 600 in embodiments of the invention. Further, the processor bus 560, the circuitry 580 and the peripheral bus 600 compose a bus system for computing system 500 in various embodiments of the invention. The microprocessor 520 starts disk access commands to access the disk 620. Commands are passed through the processor bus 560 via the circuitry 580 to the peripheral bus 600 which initiates the disk access commands to the disk 620. In various embodiments of the invention, the present system intercepts the disk access commands which are to be passed to the hard disk.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “computer readable storage medium” may be any tangible medium (but not a signal medium—which is defined below) that can contain or store a program. The terms “machine readable medium,” “computer-readable medium,” or “computer readable storage medium” are all non-transitory in their nature and definition. Non-transitory computer readable media comprise all computer-readable media except for a transitory, propagating signal.

The term “machine-readable signal” refers to any signal used to provide machine instructions and/or data to a programmable processor. A “computer readable signal medium” may be any computer readable medium that is not a computer readable storage medium and that can communicate, propagate, or transport a program.

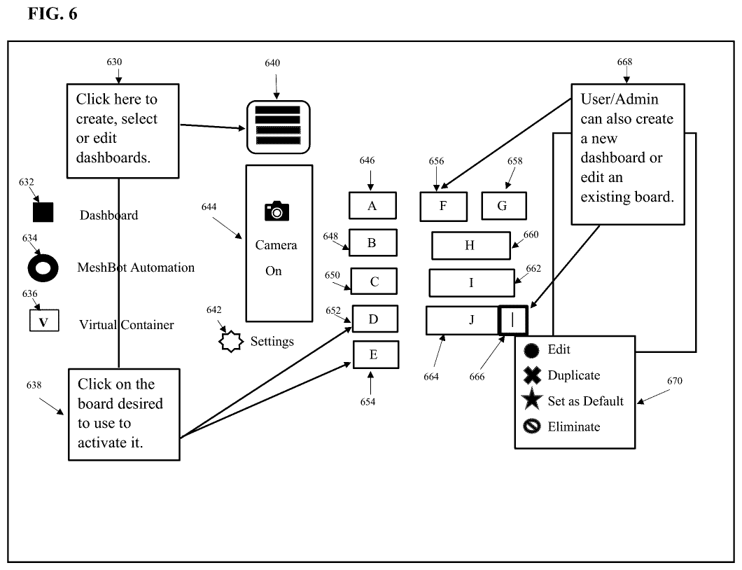

With reference to FIG. 6, there is a schematic illustration of the present invention for global meshbots, which run in the cloud and are not tied to a specific controller. This illustrates that the global meshbots are device centric and automatically find the appropriate controller to manage a device. As shown in FIG. 6, the system begins with the user taking action of clicking 630 to create, select or edit dashboards from the interface 640. From the action of clicking 630, there are the options of dashboard 632, meshbot automation 634, and virtual containers 636. The user can click on the board that is desired in order to activate it 638. These include locations, controllers, or devices as items A, B, C, D, and E (numbered as 646, 648, 650, 652, and 654). The user/administrator can also create a new dashboard or edit an existing dashboard 668. Selection of locations, controllers, or devices as items F, G, H, I, and J can be made (656, 658, 660, 662). A dropdown selection menu 666 is available for each item. Within the dropdown menu 666, are selections such as edit, duplicate, set as default, and eliminate 670. Numerous other additional known settings 642 can be included on the interface 640, such as turning a camera on/off 644.

FIG. 7 is a schematic illustration of the dashboard of the present invention indicating local meshbots interacting with devices associated by and imported to a specific controller. As seen in FIG. 7, there is shown the meshbots 635 screen which includes dashboard 632, meshbot automation 634, a virtual container section 636, and settings 642 (including controllers 642a and backup 642b). A file folder 676 is also available. The meshbot automation 634 can be applied by using the create new meshbot feature 672. Initially, the screen will have a message such as “You have no MeshBots yet,” and then the user can create meshbot manually by tapping on “Create New MeshBot” 672. After creating new meshbot 672, the automation meshbot feature 674 provides the option of creation and designating a global meshbot creation 675 or local meshbot creation 677. The meshobt can be then stored as a saved file 680. The new automation meshbot device screen 678 depicts the new automation meshbot 684 which includes the dashboard 686 and meshbot automation 688 as before. The local meshbot that is created 674 is sent to a saved file 680. The meshbot name 682 can be entered by the user as well.

What is claimed is:

1. A method comprising
acquiring code to be executed;
splitting said code into one or more chunks;
identifying for each one of said one or more chunks any resources needed for said each one of said one or more chunks;
determining access of a specific user to network items selected from the group comprising cloud instances, edge computing, memory and databases;
checking and determining that said each one of said one or more chunks of code are executable and have access to all of said resources needed;
determining a locality of said resources needed for each one of said one or more chunks of code;
reviewing all of said chunks of code and determing where said chunks of code should run, merging all consecutive chunks of code that run on a same computer unit into one unit of code;
distributing said one unit of code to all the devices that are to run said one unit of code by synchronizing said the pieces of code with devices that are to run said one unit of code.

2. The method of claim 1 further comprising determining if said chunk of said code needs to send a command to another device.

3. The method of claim 1 further comprising determining if said chunk of said code needs to read a file.

4. The method of claim 1 further comprising determining if said chunk of said code needs to store something, an item or data in a database.
